(19) United States
(12) Patent Application Publication
(10) Pub. No.: US 2002/0194356 A1
(43) Pub. Date: Dec. 19, 2002

(54) System and method of downloading music and playing the downloaded music

(75) Inventors: Koon-Chung Chan, Tsimshatsui (HK); Eric Kar-Chuen Miu, Taipei (TW)

Correspondence Address: Jie Sha, Suite 3504, 195 N. Harbor Dr., Chicago, IL, 60601, US

(73) Assignee: KaraNetwork Limited, Causeway Bay (HK)

(21) Appl. No.: 10/152,183

(22) Filed: May 21, 2002

Related U.S. Application Data
(60) Provisional application No. 60/292,481, filed on May 21, 2001.

(51) Int. Cl. G06F 15/16

(52) U.S. Cl. 709/231; 709/246

(57) ABSTRACT

A system and method of downloading and playing the downloaded music files comprises a music website that provides, through a network, music files with searchable indexing page, and a plurality of information terminals that are capable of communicating with the music website through the network and downloading and playing the music files downloaded from the music website. If it is a karaoke song, the music file is marked with position indictor at each point of changing word of lyrics along with melody of the song for synchronization. The music files will be removed from the memory of information terminal after online playing. For offline playing, the music files are encrypted when being downloaded, and will be decrypted at the information terminal for playing with verification of correct encryption key stored in the information terminal. The encryption key is created and updated regularly with the update of the virtual amplifier so as to prevent the user from distributing freely the downloaded music files.

This application is based on the U.S. Provisional Application No. 60/292,481, filed on May 21, 2001.

### FILED OF THE INVENTION

The present invention relates to a system and method of downloading music and playing the downloaded music. More particularly, it relates to a system and method of downloading the music files from the Internet and playing the downloaded music files online or offline with measures of preventing further distribution of the music.

### BACKGROUND OF THE INVENTION

Today, the Internet technology develops very fast, and downloading the music files from the Internet has become known in the art. However, at present, the music files downloaded from the Internet may only contain original songs and accompaniment, and the music files cannot contain properly karaoke songs. Further, the providers of the music files do not have any effective technique to restrict or prevent users from distributing freely the downloaded music files. Therefore, it causes or has caused huge damages to the composers, authors and/or owners of the intellectual property rights (copyrights), who cannot collect any revenue or royalty from such further distribution of the music. Therefore, these are remaining problems to be solved in the area of downloading the music from the Internet and playing thereof online or offline.

Accordingly, it is an object of the present invention is to overcome the aforesaid problems, and to provide a system of downloading music files from the Internet with restriction of further distribution of the music files.

It is another object of the present invention to provide a system of playing the downloaded music files online or offline with restriction of further distribution of the music files.

It is a further object of the present invention to provide a method of downloading music and playing the downloaded music files with restriction or prohibition of further distribution of the music files.

It is still a further object of the present invention to provide a system and method of downloading and playing karaoke music files online or offline with accurate synchronization of the words and accompanying music.

### SUMMARY OF THE INVENTION

According to the present invention, a system of downloading music and playing the downloaded music files through a network comprises a music website that provides, through the network, music files with searchable indexing page including the information of downloading and playing, and a plurality of information terminals that are capable of communicating with the music website through the network and downloading and playing the music files downloaded from the music website. The network normally refers to the Internet, and the information terminals normally refer to personal computers of end users.

The music website is any website that is able to provide music playing and downloading services, and the website includes means for encrypting the music files that are provided for downloading, and means for releasing the downloaded music files from the information terminal that has downloaded the music files. The releasing means releases the music files so as to delete the downloaded music files from the memory of the information terminal after the Information terminal has played the music files for a predetermined period of time.

According to the present invention, a method of downloading music and playing music files downloaded from a music website to information terminals through the Internet comprises the steps of uploading the music files to the music website, providing a searchable indexing page at the music website, clicking to enter the music website, searching the index to select desired music files, downloading the selected music files into a temporary folder in a local memory of the information terminal, playing online the selected music files through a virtual amplifier or player after the selection, and releasing and deleting the music files temporarily stored in the memory of the information terminal after the music files are played.

Alternatively, the method of the present invention comprises further steps of downloading selected music files into the memory of the information terminal with confirmation of users' account information, encrypting the selected music files and attaching releasing software thereto during the downloading of the selected music files, and playing the downloaded music files on the information terminal, where the information terminal decrypts the music files, keeps the music files for a predetermined period of time, and plays the music only during the predetermined period of time.

The music files may contain karaoke songs that allow users to sing along with the song words or lyric concurrently displayed on the screen of the information terminal either online or offline, and record their own singings with the accompaniment music. To accomplish this process, the system and method of the present invention may generate the accompaniment music and display the words of lyric retrieved from the selected music files containing the karaoke songs that are uploaded and stored in the music website with accurate synchronization of the accompaniment music and words displaying online. The synchronization of the accompaniment music and words is realized by marking positions in the music where the corresponding words of lyric should come out in accordance with the melody of the music.

According to the present invention, the music files downloaded in the memory of the information terminal may not be distributed freely because of the encryption of the music files and releasing of the music files after the music is played or deletion of the downloaded music files after the music is played for a predetermined period of time in accordance with a protocol between the music website and the information terminals that are allowed to download and play the music provided by the music website.

The present invention can be better understood from the following description with reference to the accompanying drawings.

### BRIEF DESCRIPTION OF THE DRAWINGS

FIG. 1 is an illustration the system of the present invention;

FIG. 2 is a flowchart of the method of downloading music and offline playing the music files in accordance with the present invention;

FIG. 3 shows the major functions of the website and the terminals for the method of the present invention as shown in FIG. 2;

FIG. 4 is a diagram of the method of the present invention of FIG. 2;

FIG. 5 is a flowchart of the method of downloading music and online playing the music files in accordance with the present invention;

FIG. 6 is shows the major functions of the website and the terminals for the method of the present invention as shown in FIG. 5;

FIG. 7 is a diagram of the method of the present invention of FIG. 5;

FIG. 8 is a flowchart of formation of encryption key;

FIG. 9 is a flowchart of addition of encryption with the encryption key;

FIG. 10 is a flowchart of decryption of the downloaded music files;

FIG. 11 is a flowchart of formation of the karaoke songs with display of words of lyrics; and

FIG. 12 shows the marking technique of the positions of word changes of lyrics in accordance with melody of the karaoke songs with words display.

### DETAILED DESCRIPTION OF THE INVENTION

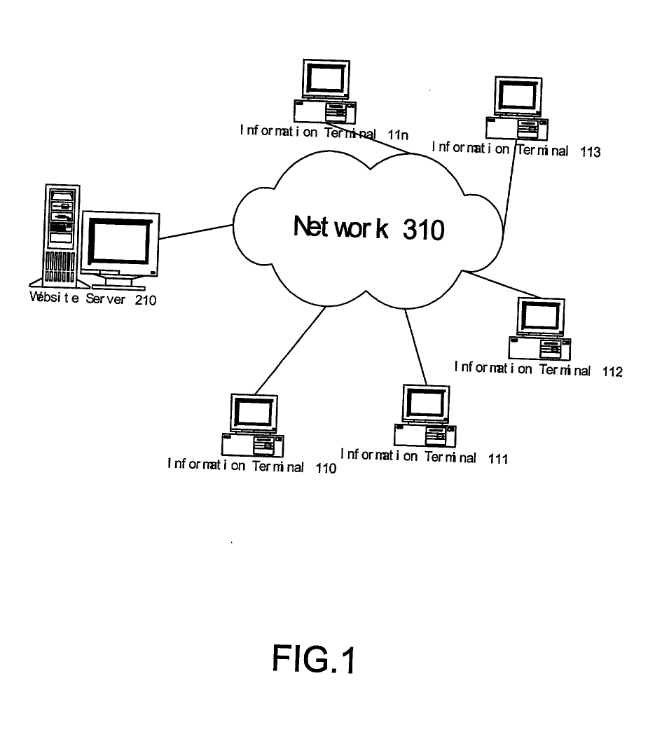

With reference to FIG. 1, the system of downloading music and playing the downloaded music files comprises at least a server 210 of music website that provides, through the network 310, music files with a searchable indexing page including the information of downloading and playing, and a plurality of information terminals 110-11n that are capable of communicating with the server 210 of the music website through the network 310 and downloading music files and playing the downloaded music files from the music website. The network normally refers to the Internet, and the information terminals normally refer to personal computers of end users. The server 210 and the information terminals 110-11n are all connected to the network 310 that is normally the Internet.

The music website server 210 contains all kinds of music, and provides its members with not only the services of downloading the latest music on the pop charts, but also other valuable services, such as tutoring or coaching of the singing skill, interviews of lyricists, composers, and singers, and even recording of users' own singings. The music website may be any website so long as it provides music playing and downloading services.

The website server 210 is equipped with means for encrypting the music files that are being downloaded upon selection by the users, and means for releasing and deleting the downloaded music files from the memory of the information terminal that has downloaded the music files. It is understood that a protocol is established between the music website server 210 and all of the information terminals 110-11n such that the users may open membership accounts, and sign on with the music website normally with users' names and passwords. The releasing means attaches software that can be used to delete automatically the downloaded music files from the memory of the information terminal after the Information terminal has played the music files for a predetermined period of time in accordance with the protocol.

Some known encryption technique may be adopted in the present invention. However, the particular encryption technique developed by KaraTA.com will work better in connection with the present invention. This encryption technique may be understood better in connection with the description of the method of the present invention hereinafter and the use of virtual amplifier called KaraAmp™ of KaraTV.com. The virtual amplifier of KaraAmp™ includes six modules of play back, record, mixer, equalizer, display, and control. The play back module has the features of play back, pause, stop, scrolling bar, drag and drop, etc. but programmed for use on the files of KTV, KR1 (encrypted file format), MIDI, MID, WAV, WMA, MP3, M3U, DAT (CD), but not limited thereto. The record module allows users to record their own singings of the karaoke songs by pressing the REC button, to save the recording file in any suitable formats, such as WAV or MP3, and to replay the recorded songs. The mixer may have adjustment of ECHO, MIDI/CD/WAVE/MIC/Line-IN, etc. and the equalizer may set for ROCK, CLASSIC, POP, JAZZ, etc. The display module may contain the front and background displays that may use, but not limited to, SWF, MPEG, MPG, AVI, DAT (VCD), JPG, JPEG, GIF, TIF (F), BMP. And the control module may set up, load, save titles of the music files in all kinds of possible indexing, and have editing function for both of lyric and music. Some information of this product KaraAmp™ may be used in connection with the establishment of membership accounts, and for log-on with the music website as part of confirmation of the users' account information with the music website.

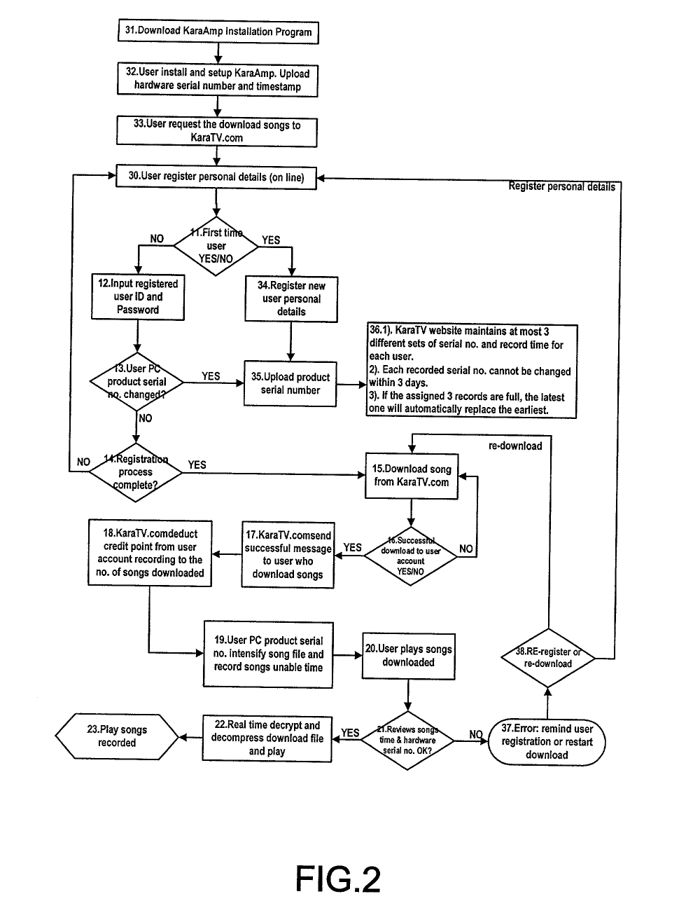

Now, referring to FIGS. 2 to 4, these figures illustrate the method of downloading and playing music files downloaded from a music website to information terminals through the Internet with measures of restricting and preventing users from arbitrarily further distribution of the downloaded music files. The downloaded music files can be played offline at the information terminal after the users log-off or sign-off. The method comprises the steps of uploading the music files to the music website, and providing a searchable indexing page at the music website before any user could use the website services as summarized hereinabove.

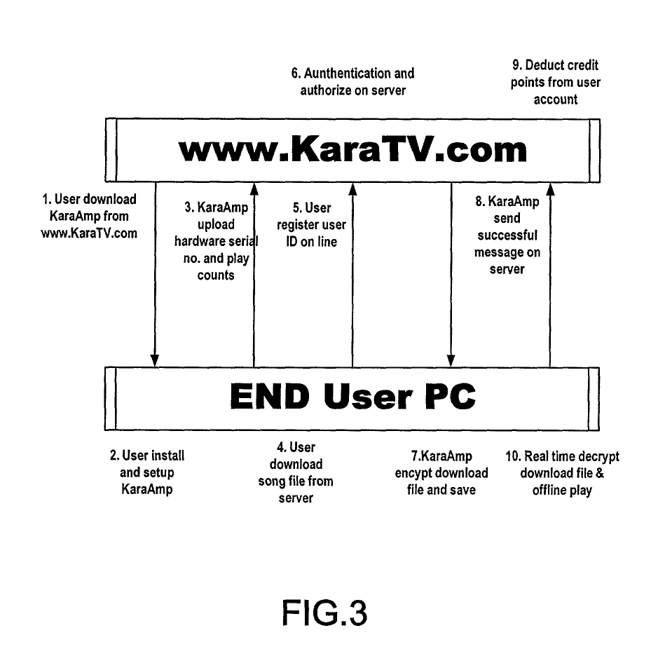

Before the users may download and play the music from the website, the users will be required to download a virtual amplifier installation software, indicated as 1 in FIG. 3 or step 31 of the flowchart in FIG. 2, from the music website, e.g., www.KaraTV.com, preferably the virtual amplifier of KaraAmp™ of the current assignee KaraNetwork Limited of this application, or any other compatible virtual amplifier that could work with the particular website in accordance with the present invention. The user then installs the KaraAmp™, and sends the product serial number as seen as 2 and 3 in FIG. 3 and the time starts to count as depicted at step 32 of FIG. 2. Then the user may click to enter the music website, and request downloading of songs or music from the music website server 210 at step 33 of FIG. 2 or as seen 4 in FIG. 3.

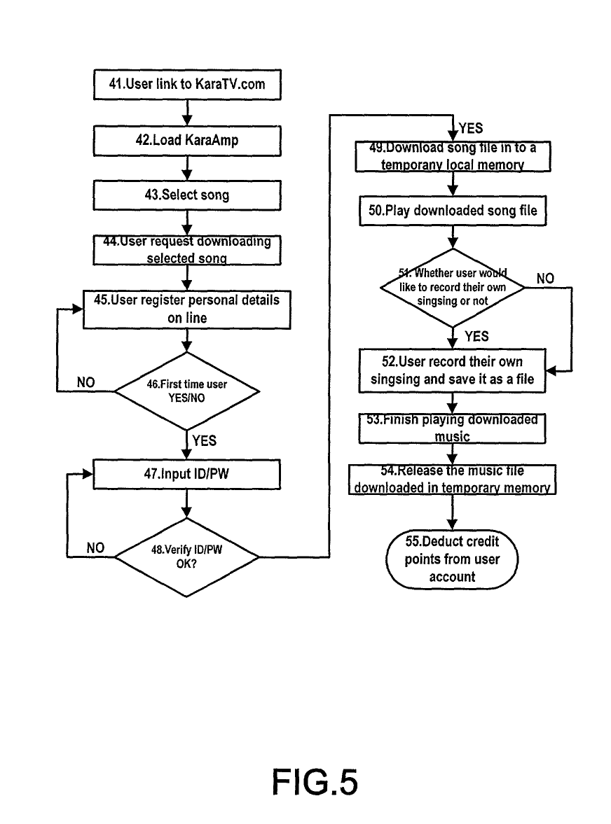

As seen in FIGS. 2 and 3, the user may then sign on and register online at step 30 in FIG. 2 or 5 of FIG. 3. If the user is the first timer (11 of FIG. 2), the system or the website will prompt the user to open an account by registering personal information at 34 and to send the product serial number of the virtual amplifier at 35. The virtual amplifier may be updated from time to time, and thus the product serial number may change accordingly. Normally, the established member account stores at 36 three sets of different product serial numbers and the recorded time, and each of the serial numbers remains unchanged for at least three days, that could be any predetermined period of time. Once three serial numbers are fully recorded, the following latest serial number will replace the earliest serial number on the record.

If the member account is established, the website will require the user to enter the user's name and password at 12 in FIG. 2. Then, the system will test whether the virtual amplifier's serial number is properly updated at 13, and the new number needs to be uploaded to the website for registration, i.e. back to the step 35. If the number is not updated, the registration is successful at 14, and the user is able to search the index to select desired music files and download the selected music files at 15. The system will check if the music is correctly downloaded into the current user's account at 16, and will notify the user if the download is successful at 17. Thus, the website will deduct proper points for the number of music files downloaded at 18. This is the verification, confirmation and recordation of the membership account as depicted 6 and 8, 9 in FIG. 3.

Further, the method of the present invention comprises the steps of encrypting the selected music files and attaching the releasing software thereto during the downloading of the selected music files at step 19 of FIG. 2, and the server 210 also records the time of the downloading and assign the predetermined period of time to the information terminal of the user to play the music. The user may then play the downloaded music files on the information terminal at 20. However, at each time the user plays the downloaded music, the system will check if the time of the music and the product serial number are valid at 21. If they are valid, the information terminal will then decrypt and decompress the music files at 22 and play the music at 23. That is retrieving the music files and playing the music as depict as 10 of FIG. 3. If the time of the music or the product number is invalid, the user will be reminded at 37 to either download the music again or register online again at 38. This means the music files can only be played for a predetermined period of time, and the member account should be updated from time to time by using the updated serial numbers of the virtual amplifier.

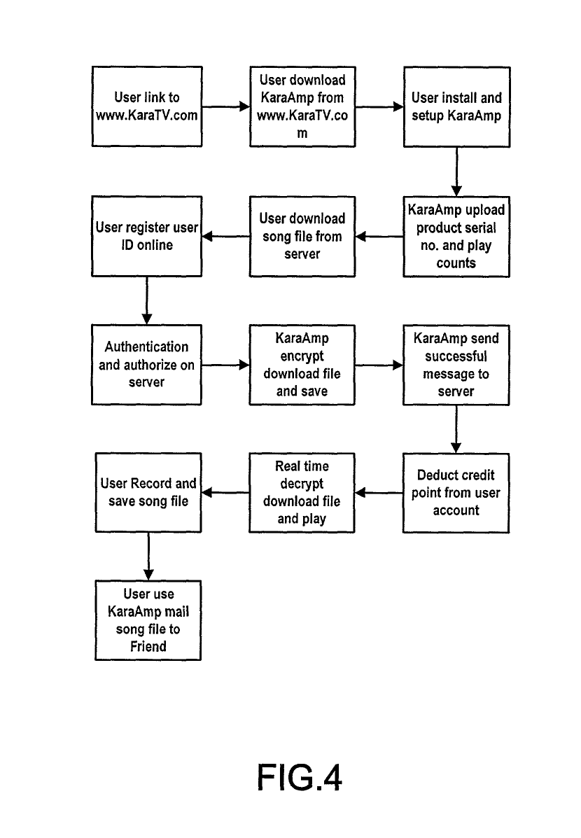

Generally speaking, the website will perform the functions of providing and updating the virtual amplifier, such as KaraAmp™, and installing software thereof, receiving and recording the updated product serial number, providing online registration page, verifying the registration information, providing the music files for downloading, encrypting the music files while downloading, notifying the user the success of downloading, and deducting the points of downloading the music. The functions of the information terminal include installing the virtual amplifier software, storing the encrypted music files, and decrypting the downloaded music files for playing. This can be seen either in FIG. 3 or FIG. 4.

FIG. 4 is a general block diagram indicative of the aforesaid steps of the present invention with respect to www.KaraTV.com. During the playing of the downloaded music, the user may want to record own singings for future playing. The user may also want to send to friends the own singings recorded with KaraAmp™.

FIG. 5 shows the method of downloading and playing music files online with respect to the music website, such as www.KaraTV.com. The flowchart is similar to the one as shown in FIG. 2 of offline playing of the downloaded music. Anyone may access and open the home page of the music website at 41, download a virtual amplifier or player at 42, and select songs or music from the websites at 43. However, when the user requests to download and play the desired music at 44, the system will require the user to register at 45 with all necessary information, such as credit card information etc. If it is the first time using the website, the user will be required to fill in some additional information at 46. Otherwise, the user's name and password are required at 47, and if the password is incorrect it may be reentered at 48. Upon verification, the selected music files can be downloaded in a temporary local memory of the system at 49, and the downloaded music can then be played at 50.

As prompted at 51, if the user would like to record their own singing when playing the karaoke songs online, the user may record it at 52, and then finish the playing at 53. If the user will not record the sing-along songs, the playing of the downloaded music will end at 53. After playing or when the user signs off, the music files downloaded in the temporary folder or file will be released or removed automatically at 54, and certain points from the user's account will be deducted at 55 accordingly for the music played.

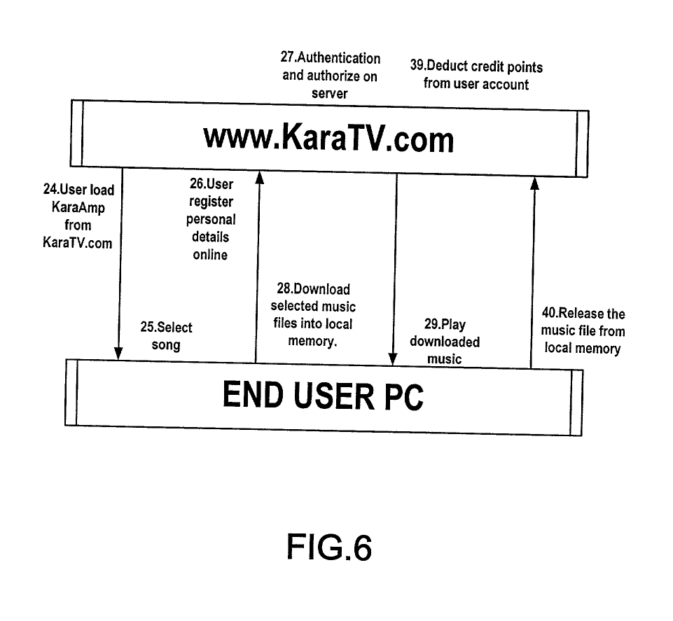

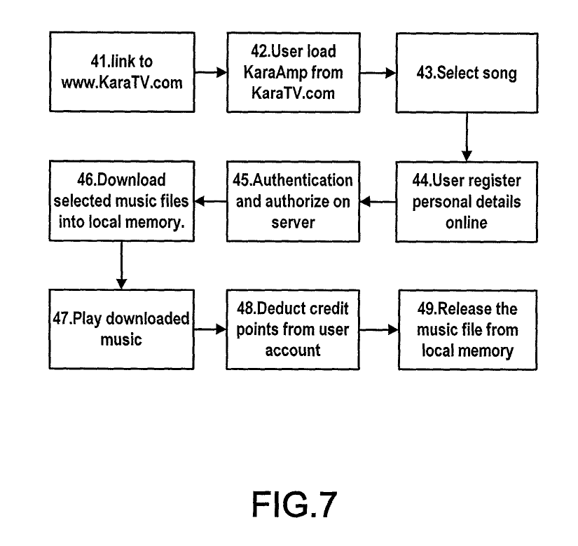

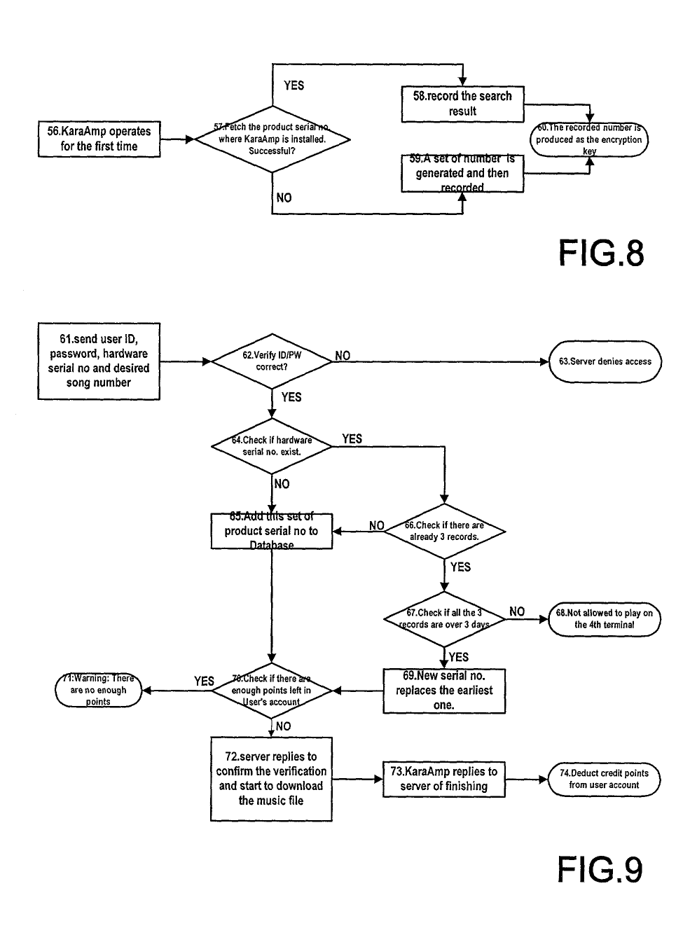

FIG. 6 generally indicates the aforesaid online downloading and playing of music from the website, such as www.KaraTV.com. Similar to FIG. 3, the music website server 210 will perform the functions of providing and loading the virtual amplifier (24), registering (26) and verifying the user's information (27), providing music with attached release software for downloading, and deducting the points for the music downloading (39). The information terminal 110-11n will perform the function of selecting the music or songs (25), downloading the selected music files into the local memory (28), playing the download music (29), and releasing the music files from the local memory upon finishing of the music playing (40). FIG. 7 is a general block diagram showing the method steps of online downloading and playing of music of the present invention as discussed above. With reference to FIGS. 8, 9 and 10, these figures illustrate the use of KaraAmp™ software or program in connection with the present invention to provide certain restriction or prevention of any likelihood of further distribution of the music or music files downloaded from the music website, such as the site of www.KaraTV.com. Although other programs might be used, the software or program of KaraAmp™ (for the virtual amplifier or player) is preferred as it is specially designed for realizing the method of the present invention and for use in the system of the present invention with precaution and measures of restricting and preventing users from further distribution of copyrighted music works.

FIG. 8 shows the formation of the encryption key for the method and system of the present invention. When the virtual amplifier KaraAmp™ operates for the first time (56), the serial number of this virtual amplifier is searched against the stored serial numbers in the hardware of the information terminal at 57. If the search succeeds, the serial number is then recorded at 58, and if not, a set of numbers will be generated and then recorded at 59. After the recordation at either 58 or 59, the product serial number is produced as the encryption key at 60.

FIG. 9 illustrates the formation of encryption, as KaraAmp sends the user's ID, password, desired music number or numbers, and product serial number to the website server 210 at 61, the website server 210 will first check whether the user's ID and password are correct at 62. If they are not correct, the server 210 will turn down the user's request at 63, and if they are correct, the server 210 will check if the encryption key, that is, the product serial number, exists at 64. If it does not exit, the set of numbers of encryption key is added to the database at 65. If it does exit, the server will check if there are already three sets of numbers at 66. If not, then the number will still be added to the database, while if there are three sets of numbers, they will be checked to see whether any of them is over three days or a predetermined period of time at 67. If all of them are not over three days old, the server will reply that there are more than three computers (information terminals) at 68.

If any of them is over three days old, the new entered serial number will replace the oldest one at 69. Then, after the new encryption key is added at 65 or 69, the server 210 will check whether there are enough points left in the user's account at 70. If there is not enough point, the server 210 will warn the user at 71. However, if there are enough points, the server 210 will reply to confirm the verification, and start downloading of the music at 72. Then, the information terminal indicates finishing of the downloading at 73, and deducts the points from the user's account at 74.

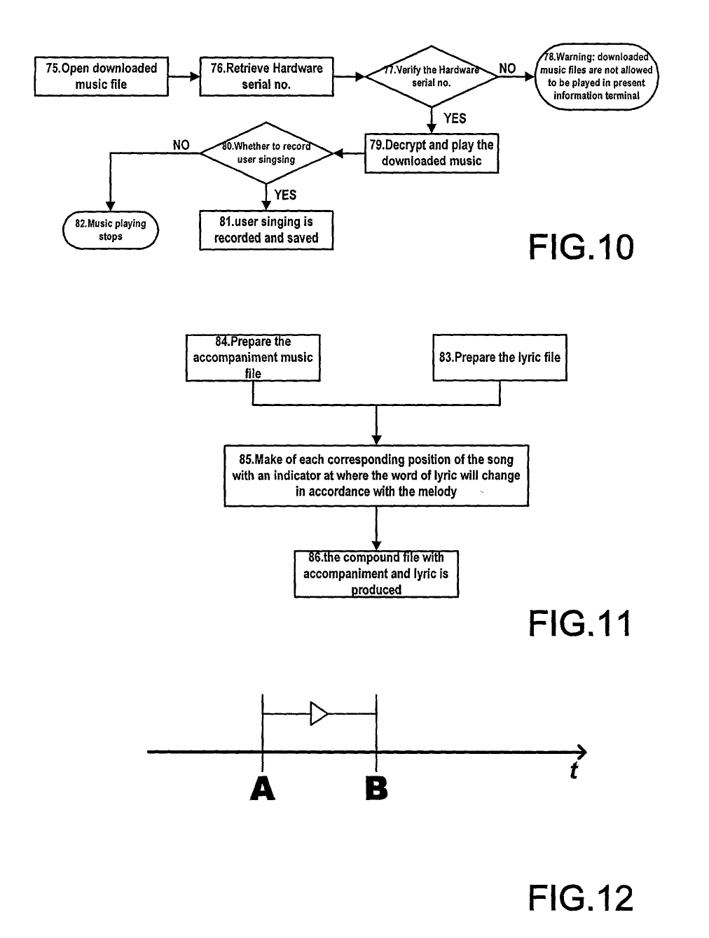

FIG. 10 illustrates the decryption procedure. As seen therein, at the step 75, the downloaded music is opened, and the product serial number is read (76). The serial number is checked to see if it is correct (77), and if it is incorrect, the information terminal will warn the user that this music file cannot be played at the present information terminal or computer (78). If the number is correct, the music file will be decrypted, and begin to play. If the music file is a karaoke file, the terminal will ask whether or not the user would like to record his or her or their own singing at 80, and the playing will stop at 82 if the user does not choose recording. If the user wants to record, then the singing can be recorded and stored at 81.

Through the above discussion, it can be seen that the product number of the virtual amplifier is used to create an encryption key, and the key can be used for encryption of downloading music files. In this way, the downloaded music can only be played either just for online playing, or played offline for a predetermined period of time. This means the restriction may be created for the downloaded music to prevent the user from further distribution of the music without proper authorization. Here, the assignee's KaraAmp™ virtual amplifier is described. However, it should be understood that the serial number of any kind of virtual amplifiers or any other numbers associated with the playing of the downloaded music may be used for the encryption and release as discussed hereinabove without departing from the inventive concept of the present invention.

As stated above, the music files may contain karaoke songs that allow users to sing along with the words of lyrics concurrently displayed on the screen of the information terminal either online or offline, and record their own singings with the accompaniment music. FIG. 11 shows how the system and method of the present invention may generate the screen display of the words of lyric synchronized accurately with the accompaniment music retrieved from the selected music files. It includes preparation of the lyrics at 83 and preparation of the karaoke song at 84, marking each corresponding position of the song with an indicator at where the word of lyrics will change in accordance with the melody of the song at 85, and then the compound file including accompaniment and lyric is generated at 86.

FIG. 12 shows an example of how the compound song with the accurate marking is made. A is the starting time of a word in the lyrics of a song, X represents the time interval the word will last and change, and B is the ending time of the word. Therefore, the song having the word display will be recorded with such marking, such as A_X_B. This kind of marking is applied to every word or character or segment of a word (if the word is prolonged for singing). It might be understood that such marking can be adopted at intervals of microseconds. Thus, the marking can accurately synchronize the songs with words of lyrics.

What we claim is:

1. A system of downloading and playing music files through a network, said system comprising a music website that provides, through the network, music files with a searchable indexing page including the information of downloading and playing, and a plurality of information terminals that are capable of communicating with the music website through the network and downloading and playing the music files downloaded from the music website, wherein the website includes means for encrypting the music files that are provided for downloading, and means for releasing the downloaded music files from the information terminal that has downloaded the music files, and wherein the releasing means includes software that is used the release the downloaded music files so as to delete the downloaded music files from the information terminal after the Information terminal has played the music files for a predetermined period of time.

2. The system of claim 1, wherein the network is the Internet, the information terminals refer to personal computers of end users, and the music website is an website that is able to provide music playing and downloading services.

3. The system of claim 1, wherein the releasing means is capable of clearing automatically the temporarily downloaded music files from the information terminal after the terminal plays the music online.

4. The system of claim 1, wherein the encrypted files of music are decrypted for playing offline when the music files are downloaded.

5. The system of claim 4, wherein an encryption key is created using a number of a product associated with playing of the downloaded music.

6. The system of claim 5, wherein the number of the product is the serial number of a virtual amplifier that is used for playing the downloaded music files.

7. The system of claim 4, wherein the encryption key is updated when the product of playing the downloaded music files is updated from time to time.

8. The system of claim 1, wherein the music files contain karaoke songs with accompaniment and display of words of lyrics, said words changing along with melody of the song.

9. The system of claim 8, wherein each position of the melody of the song where the word of lyrics changes and the interval between two positions are marked with synchronizing indicators.

10. A method of downloading and playing music files downloaded from a music website to information terminals through a network, said method comprising the steps of uploading the music files to the music website, providing a searchable indexing page at the music website, clicking to enter the music website after a user signs on the network, searching the index to select desired music files, downloading the selected music files into a temporary folder in a local memory of the information terminal, playing online the selected music files through a virtual player after the selection, and releasing and deleting the music files temporarily stored in the memory of the information terminal after the music files are played online.

11. The method of claim 10, wherein the music files include karaoke songs with accompaniment and display of words of lyrics, said words changing along with melody of the song.

12. The method of claim 11, wherein each position of the melody of the song where the word of lyrics changes and the interval between two positions are marked with synchronizing indicators before the music files are uploaded to the website.

13. The method of claim 11, wherein the singing of the karaoke songs may be recorded at the information terminal during the online playing of the song.

14. The method of claim 11, further comprising the steps of verifying a member account of the user at the music website, wherein the member account includes at least a preinstalled and stored serial number of the virtual player for identification of updated membership of the information terminal.

15. A method of downloading and playing music files downloaded from a music website to information terminals through a network, said method comprising the steps of uploading the music files to the music website, providing searchable indexing page at the music website, clicking to enter the music website after a user signs on the network, searching the index to select desired music files, downloading the selected music files into the memory of the information terminal including the update of the encryption key, encrypting the selected music files, decrypting the downloaded music files before playing with verification of the encryption key stored at the information terminal, and playing the downloaded music files on the information terminal.

16. The method of claim 15, wherein said encryption key is created with a serial number of a virtual amplifier for playing the downloaded music files, and downloaded to the information terminal with the update of the virtual amplifier from time to time.

17. The method of claim 16, wherein said encryption key is downloaded with the downloading of the music files, and used to decrypt the music files downloaded at the information terminal before playing of the music files at the terminal with confirmation of the encryption key thereat.

18. The method of claim 15, wherein the music files contain karaoke songs with accompaniment and display of words of lyrics, said words changing along with melody of the song.

19. The method of claim 18, wherein each position of the melody of the song where the word of lyrics changes and the interval between two positions are marked with synchronizing indicators.

20. The method of claim 15, further comprising installing and updating an encryption key to a member account of the user at the music website, verifying and confirming the member account with updated serial number of the encryption key.
